(19) United States
(12) Patent Application Publication
(10) Pub. No.: US 2012/0153819 A1
(43) Pub. Date: Jun. 21, 2012

(54) ELECTRODE, MANUFACTURING METHOD THEREFOR, AND HIGH PRESSURE DISCHARGE LAMP

(75) Inventors: Yasuhisa Matsumoto, Gyoda-shi (JP); Kouji Komata, Gyoda-shi (JP)

(73) Assignee: IWASAKI ELECTRIC CO., LTD., Chuo-ku, Tokyo (JP)

(21) Appl. No.: 13/391,942

(22) PCT Filed: Sep. 1, 2010
(86) PCT No.: PCT/JP2010/064916

§ 371 Date: Feb. 23, 2012

(30) Foreign Application Priority Data
Sep. 9, 2009 (JP) 2009-207692

(51) Int. Cl. H01J 61/073; H01J 9/04; H01J 1/20

(52) U.S. Cl. 313/631; 313/310; 445/46

(57) ABSTRACT

In an electrode having a structure in which a coil is wound around an electrode rod, an ignition performance is ensured while preventing abnormal discharge and sputtering, an appropriate electrode temperature is obtained during drive, and having this operation maintained even if the lamp is repeatedly turned on and off. A discharge lamp electrode (30) having an electrode rod (10) and a coil (20) wound around a discharge portion (11) of the electrode rod includes a first welding portion (41) in which a front end of the coil is welded to the discharge portion, a second welding portion (42) in which a rear end of the coil is welded to the discharge portion, and a weld-joining portion (50) in which at least a pair of adjacent coil portions in windings of the coil are welded to each other.

### TECHNICAL FIELD

The present invention relates to an electrode and a high pressure discharge lamp using the same.

### BACKGROUND ART

In high pressure discharge lamps, a pair of electrodes are disposed inside a bulb, and electrons are emitted from a cathode to an anode in accordance with a voltage applied between the two electrodes. Patent Document 1, for example, discloses an electrode formed of an electrode rod and a coil wound around the electrode rod, in which a coil rear end portion is welded all around to the electrode rod (see FIG. 2 and of Patent Document 1, in particular, a portion designated by reference numeral 222).

In an operation to ignite the lamp, an ignition voltage is applied between the electrodes, and emission of electrons starts once the electrode (cathode) reaches a temperature high enough for discharge. In general, the electron emission starts from the vicinity of the rear end portion of the coil (the root side of the rod). Here, a wire member of a small diameter is used for the coil in order to facilitate the electron emission from the coil by quickly heating the coil. Thus, the coil functions as an ignition assisting member. Meanwhile, at the cut ends of the end portions of the coil, the electronic state is unstable and thus abnormal discharge and sputtering are likely to occur in the ignition. For this reason, the coil rear end portion is desirably welded and integrated with the electrode rod.

In addition, the portion having the highest temperature during the steady driving of the lamp is a tip portion of the electrode rod. The coil transfers this heat from the coil front end portion to the coil rear end portion, so that the heat at the tip portion of the electrode is dissipated toward a rear side of the electrode rod. As a result, the temperature of the electrode is maintained properly and stably, which thereby stabilizes the discharge. Thus, the coil functions as a heat dissipating member as well.

### PRIOR ART DOCUMENT

### Patent Document

Patent Document 1: Japanese Patent Application Laid-open No. 2006-79986

### SUMMARY OF THE INVENTION

### Problems to be Solved by the Invention

However, welding the coil rear end portion to the electrode rod with a large contact area as in the case of Patent Document 1 increases the thermal capacity of the vicinity of the coil rear end portion and therefore slows down the temperature rise at the coil portions during the ignition. This suppresses the function of the coil as the ignition assisting member, and causes a problem of deterioration in the ignition performance.

In addition, if a lamp is repetitively turned on and off using the electrode as described in Patent Document 1, thermal expansion and shrinkage of the electrode rod made of tungsten gradually loosens adjacent coil portions. As a result, a gap occurs between the coil and the electrode rod. This gap reduces the contact area between the coil and the electrode rod or between the adjacent coil portions and impairs the thermal conductivity. Consequently, the thermal dissipation effect of the coil is lost. Thus, the above-described configuration becomes unable to properly maintain the temperature of the electrode, causing a problem of unstable discharge.

Therefore, in an electrode having a structure in which a coil is wound around an electrode rod, an objective is to ensure the ignition performance while preventing abnormal discharge and sputtering originating from the coil, obtain an appropriate electrode temperature during the driving of the lamp, and have the above operation maintained even if the lamp is repeatedly turned on and off.

### Means for Solving the Problems

A first aspect of the present invention provides an electrode (30) of a discharge lamp including an electrode rod (10), a coil (20) wound around a discharge portion (11) of the electrode rod, a first welding portion (41) at which a front end portion of the coil is welded to the discharge portion, a second welding portion (42) at which a rear end portion of the coil is welded to the discharge portion, and a weld-joining portion (50) at which at least a pair of coil portions in windings of the coil are welded to each other.

Here, the weld-joining portion is arranged to include a first weld-joining portion (51) at which a front end portion of the coil and a coil portion adjacent thereto are welded to each other, and a second weld-joining portion (52) at which a rear end portion of the coil and a coil portion adjacent thereto are welded to each other.

Further, a welding portion (43, 44, 45, 46, 47) may be provided in a certain position between the front end portion of the coil and the rear end portion of the coil.

Furthermore, the discharge portion with a recess (13, 14) may be provided in at least one of a position at which the front end portion of the coil is located and a position at which the rear end portion of the coil is located.

A second aspect of the present invention provides a high pressure discharge lamp (70) including a bulb (60), and a pair of the electrodes (30) according to the first aspect located inside the bulb.

A third aspect of the present invention provides a manufacturing method for an electrode of a discharge lamp, including a step (S105) of winding a coil around a discharge portion of an electrode rod, a step (S110) of welding at least a front end portion of the coil and a rear end portion of the coil to the discharge portion, and a step (S115) of welding between at least a pair of adjacent coil portions of the coil to each other.

Here, the step (S115) may include welding the front end portion of the coil and a coil portion adjacent thereto to each other, and welding the rear end portion of the coil and a coil portion adjacent thereto to each other.

### BRIEF DESCRIPTION OF THE DRAWINGS

FIG. 1 is a diagram for illustrating an overview of the present invention.

FIG. 2A is a diagram showing an electrode of the present invention.

FIG. 2B is a diagram for illustrating the electrode of the present invention.

FIG. 3A is a diagram for illustrating the electrode of the present invention.

FIG. 3B is a diagram for illustrating the electrode of the present invention.

FIG. 3C is a diagram for illustrating the electrode of the present invention.

FIG. 3D is a diagram for illustrating the electrode of the present invention.

FIG. 4 is a diagram showing a modified example of the electrode of the present invention.

FIG. 5 is a diagram showing a high pressure discharge lamp of the present invention.

FIG. 6 is a flowchart showing a manufacturing method for an electrode of the present invention.

### MODES FOR CARRYING OUT THE INVENTION

### Overview of Present Invention

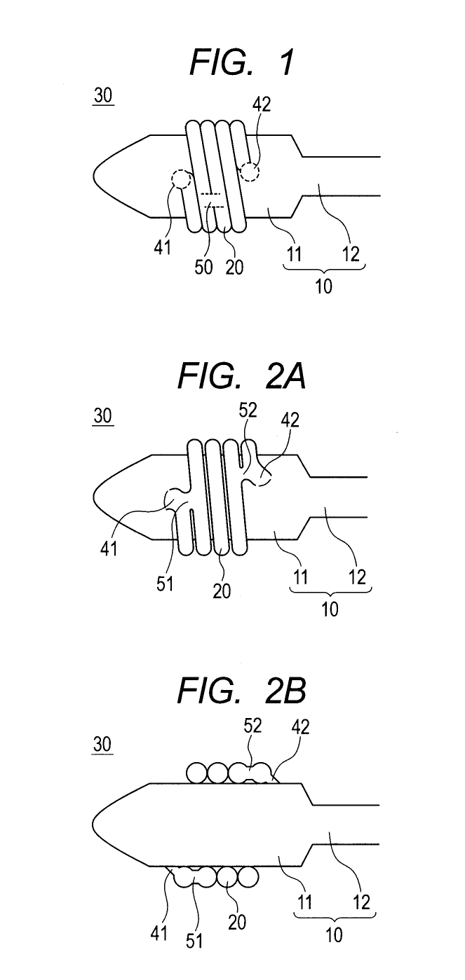

FIG. 1 shows an overview of the present invention. In the present invention, an electrode 30 formed of an electrode rod 10 and a coil 20 wound around a discharge portion 11 of the electrode rod 10 includes: a welding portion 41 at which a front end portion of the coil 20 is welded to the discharge portion 11; a welding portion 42 at which a rear end portion of the coil 20 is welded to the discharge portion 11; and a weld-joining portion 50 at which, among the windings of the coil 20, given adjacent coil portions are welded to each other.

### Embodiment

FIG. 2A shows an electrode 30 of an embodiment of the present invention. FIG. 2B is a schematic cross-sectional view of the electrode 30 in FIG. 2A, viewed from a lateral side. An electrode rod 10 is formed of a large-diameter discharge portion 11 (hereinafter also referred to as “discharge portion 11”) and a small-diameter portion 12. The coil 20 is wound around the discharge portion 11. Note that in this embodiment, the electrode rod 10 is described as one formed of the large-diameter discharge portion and the small-diameter portion as the most preferable example; however, this embodiment is applicable to an electrode rod having a fixed diameter as in the case of Patent Document 1.

Similarly to FIG. 1, the electrode 30 includes a welding portion 41 at which a front end portion of the coil 20 is welded to the discharge portion 11, and a welding portion 42 at which a rear end portion of the coil 20 is welded to the discharge portion 11.

Moreover, in this embodiment, the given weld-joining portion 50 shown in FIG. 1 includes a weld-joining portion 51 at which the front end portion of the coil 20 and its adjacent coil portion are welded together, and a weld-joining portion 52 at which the rear end portion of the coil 20 and the adjacent coil portion are welded together.

Welding of the respective portions can be done by using laser irradiation or the like as in the case of the related art.

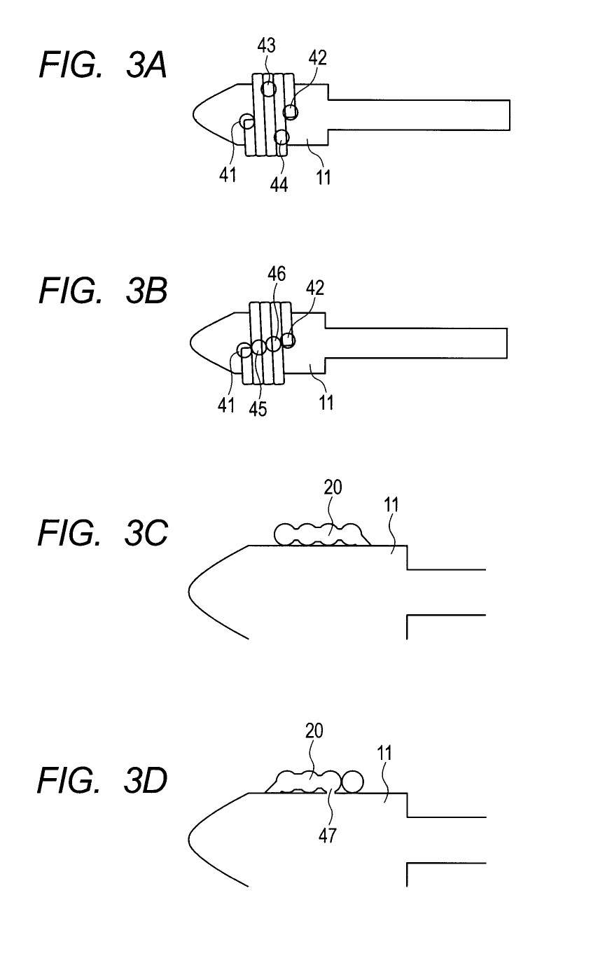

In FIGS. 2A and 2B, the welding portions are provided at the coil front end portion and the coil rear end portion, respectively. However, the welding spots are not limited to these positions. The welding portions may be provided at locations other than the coil front end portion and the coil rear end portion as shown in FIGS. 3A, 3B, and 3D.

Here, spreading out the welding spots like welding portions 41, 42, 43, and 44 in FIG. 3A allows for ensuring the bond between the discharge portion 11 and the coil 20 with a fewer welding portions (i.e., a fewer welding steps).

Moreover, when the welding spots are arranged on a straight line or on the substantially same plane as shown in FIG. 3B, the electrode 30 and the welding laser need to move relative to each other only by a short distance in the welding steps, which allows for simpler welding steps.

Moreover, in FIGS. 2A and 2B, the weld-joining portions 50 between the coil portions are provided as a portion (51) including the coil front end portion and as a portion (52) including the coil rear end portion. However, the weld-joining portion may be provided at portions not including the front coil end portion and the coil rear end portion as shown in FIGS. 3C and 3D. Although the weld-joining portion can be in any locations as described above, the number of times of laser irradiation can be minimized when the weld-joining portions 51 and 52 and the welding portions 41 and 42 are integrated at the portions including the coil end portions.

Each of the above-described configurations of the welding portions allows the coil rear end portion and the electrode rod to be welded with a minimum contact area. Hence, abnormal discharge and sputtering from the rear end portion (cut end) of the coil can be prevented, and, at the same time, the thermal capacity of the welding portions of the coil rear end portion and the electrode rod can be made smaller. Accordingly, the ignition performance can be improved.

Each of the above-described arrangements of the weld-joining portions and the welding portions prevents the coil from loosening even when a thermal stress is applied by the repetition of the discharge and stop thereof. Accordingly, the thermal conduction from the electrode rod to the coil through the welding portions can be maintained, and also the thermal transfer performance of the coil itself is maintained, which allows the thermal dissipation effect of the coil to be improved.

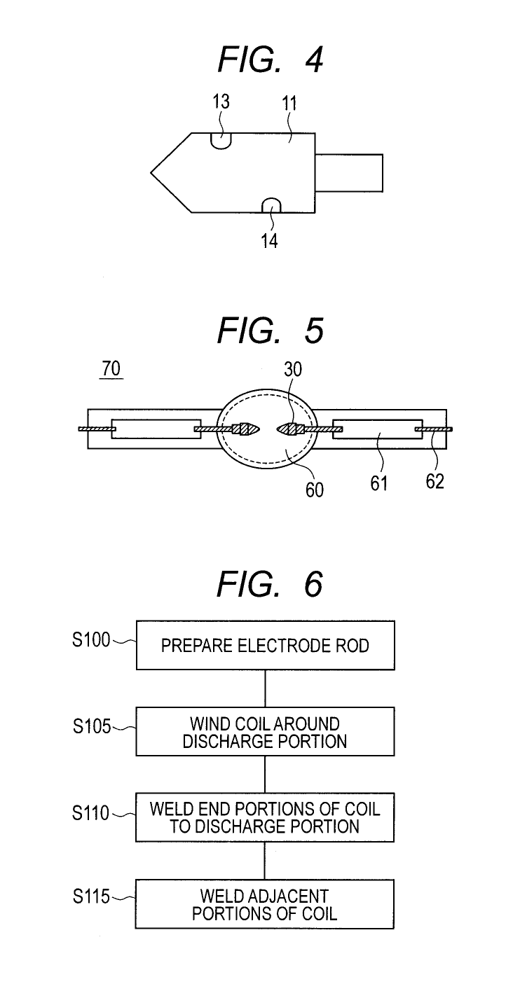

FIG. 4 shows a modified example of the electrode rod 10 of the present invention. In FIG. 4, the discharge portion 11 has recesses 13 and 14. The recesses 13 and 14 are provided in positions corresponding to the coil front end portion and the coil rear end portion, respectively. Note that only one of the recesses 13 and 14 may be provided.

As a result, both end portions of the coil 20 are welded to the recesses 13 and 14, thereby improving the wettability of the welding portions, which allows for the increased bond strength between the discharge portion 11 and the coil 20.

FIG. 5 shows a high pressure discharge lamp 70 employing the electrode of the embodiment described above. The high pressure discharge lamp 70 includes a bulb 60 and a pair of the above-described electrodes 30 arranged facing each other inside the bulb 60. Moreover, the bulb 60 includes molybdenum foils 61 and leads 62 connected to the electrodes 30, respectively. Each lead 62 is connected to a lamp driver (not shown) and applied with a voltage.

According to the high pressure discharge lamp described above, it is possible to obtain a highly reliable high pressure discharge lamp which suppresses the occurrence of abnormal discharge and sputtering originating from ignition operation and also has the improved ignition performance. It is also possible to obtain a high pressure discharge lamp which has stable drive properties and resistance to repetition of turning on and off.

FIG. 6 is a flowchart showing a manufacturing method for an electrode of the present invention.

In step S100, the electrode rod 10 is prepared. The electrode rod 10 may be formed from a rod material designed for the electrode rod by cutting the small-diameter portion 12 out of the material while leaving a portion of the large-diameter discharge portion 11 uncut. Alternatively, the electrode rod 10 may be formed by welding the large-diameter discharge portion and the small-diameter portion 12 that are separately prepared to each other.

In step S105, the coil 20 is wound around the discharge portion 11.

In step S110, at least the front end portion and the rear end portion of the coil 20 are spot-welded to the discharge portion 11 by laser irradiation or the like to form multiple welding portions.

In step S115, at least a pair of adjacent coil portions of the coil 20 are welded to each other to form the weld-joining portion.

In the above description, step S115 is performed after step S110, but the order may be reversed, or the two steps may be done back and forth.

For example, in the manufacturing of the electrode 30 in FIG. 2A, (1) the welding portions 41 and 42 may be formed in step S110, and the weld-joining portions 51 and 52 may be formed thereafter in step S115, (2) the weld-joining portions 51 and 52 may be formed in step S115, and the welding portions 41 and 42 may be formed thereafter in step S110; or (3) steps S110 and S115 may be done back and forth in such a manner that the welding portion 41 is formed in step S110, the weld-joining portion 51 is formed in step S115, the weld-joining portion 52 is formed in step S115, and then the welding portion 42 is formed in step S110 (or in reverse order), and so forth. In particular, the procedure (3) provides high operational efficiency of the laser irradiation.

### EXPLANATION OF REFERENCE NUMERALS

10 electrode rod
11 (large-diameter) discharge portion
12 small-diameter portion
13, 14 recess
20 coil
30 electrode
41 to 47 welding portion
50 to 52 weld-joining portion
60 bulb
70 high pressure discharge lamp

1. An electrode (30) of a discharge lamp comprising:
an electrode rod (10);
a coil (20) wound around a discharge portion (11) of the electrode rod;
a first welding portion (41) at which a front end portion of the coil is spot-welded to the discharge portion;
a second welding portion (42) at which a rear end portion of the coil is spot-welded to the discharge portion; and
a weld-joining portion (50) at which at least a pair of adjacent coil portions in windings of the coil are welded to each other at one part in a loop of the windings.

2. The electrode according to claim 1, wherein
the weld-joining portion comprises:
a first weld-joining portion (51) at which the front end portion of the coil and a coil portion adjacent thereto are welded to each other at one part in a loop of the windings, and
a second weld-joining portion (52) at which the rear end portion of the coil and a coil portion adjacent thereto are welded to each other at one part in a loop of the windings.

3. The electrode according to claim 1, further comprising a welding portion (43, 44, 45, 46, 47) provided at one part of a loop of the windings of the coil in a position between the front end portion of the coil and the rear end portion of the coil.

4. The electrode according to claim 1, wherein the discharge portion has a recess (13, 14) in at least one of a position at which the front end portion of the coil is located and a position at which the rear end portion of the coil is located.

5. A high pressure discharge lamp (70) comprising:
a bulb (60); and
a pair of the electrodes (30) according to claim 1 located inside the bulb.

6. A manufacturing method for an electrode of a discharge lamp comprising the steps of:
(S105) winding a coil around a discharge portion of an electrode rod;
(S110) spot-welding a front end portion of the coil and a rear end portion of the coil to the discharge portion; and
(S115) welding at least a pair of adjacent coil portions of the coil to each other at one part of a loop of windings.

7. The manufacturing method according to claim 6, wherein the step (S115) includes:
welding the front end portion of the coil and a coil portion adjacent thereto to each other at one part of a loop of the windings, and
welding the rear end portion of the coil and a coil portion adjacent thereto to each other at one part of a loop of the windings.
